(19) United States
(12) Patent Application Publication
(10) Pub. No.: US 2011/0229854 A1
(43) Pub. Date: Sep. 22, 2011

(54) ABUTMENT FOR CONNECTING A DENTAL IMPLANT WITH A DENTAL PROSTHESIS AND PRODUCTION THEREOF

(76) Inventor: Titus FISCHLER, Zeiningen (CH)

(21) Appl. No.: 12/859,787

(22) Filed: Aug. 20, 2010

(30) Foreign Application Priority Data
Mar. 18, 2010 (EP) 10156833.5

(51) Int. Cl. A61C 8/00; B23Q 11/00

(52) U.S. Cl. 433/174; 409/131

(57) ABSTRACT

A process is disclosed for producing a connector (1) for connecting a dental implant (2) with a dental prosthesis, wherein said connector (1) comprises a body portion (11) at whose one end a prosthesis attachment structure (13) and at whose opposite end an implant attachment structure (12) are configured. The process comprises collecting implant position data defining the position and alignment of the dental implant (2) inserted in a jaw (3); determining prosthesis position data defining the target position and target alignment of the prosthesis attachment structure (13) of the connector (1); and forming said connector (1) using the implant position data and the prosthesis position data, wherein said body portion (11) is configured such that the prosthesis attachment structure (13) is arranged in the target position and target alignment when said connector (1) is attached to the dental implant (2) via the implant attachment structure (12). It is possible with the process according to the invention that the target position and target alignment of the prosthesis attachment structure (13) of the connector (1) can be determined such that inaccuracies during the implantation of the dental implant (2) can be compensated for. It is possible with said process to produce an individual connector (1) which comprises a body portion (11) configured so as to be adapted to the exact target position of the dental prosthesis. The length of the connector (1), for example, can be configured so as to be adapted to the position and alignment of the dental implant (2) implanted into a jaw as well as to the target position and target alignment of the prosthesis attachment structure (13). Thus, with such an individual connector (1) it is possible to mount the dental prosthesis in a relatively efficient, easy way without the prosthesis attachment structure (13) being subject to increased strain.

### CROSS-REFERENCE TO RELATED APPLICATIONS

This application claims priority from European application EP 10 15 6833.5, filed Mar. 18, 2010, which is incorporated herein by reference in its entirety.

### FIELD OF THE INVENTION

The invention relates to a process, a milling device for carrying out the process, a computer program for controlling the milling device as well as a connector. Such processes can be used for producing a connector for connecting a dental implant with a dental prosthesis wherein the connector comprises a body portion at whose one end a prosthesis attachment structure and at whose opposite end an implant attachment structure are configured. Such connectors can further be used for connecting a dental implant with a dental prosthesis, said dental implant comprising a body portion at whose one end a prosthesis attachment structure and at whose opposite end an implant attachment structure are configured.

### BACKGROUND OF THE INVENTION

In dentistry, damaged or diseased teeth are nowadays regularly replaced with artificial dentures. Such dentures can be configured in various ways as partial or full dentures as well as fixed or removable dentures. Dentures often comprise a dental implant, a connector or abutment, respectively, and a dental prosthesis. When replacing a tooth, the dental implant is engrafted as an artificial root of the tooth at a target place in a jaw bone. To this end, the jaw bone is partially treated in advance in that, for example, bone substance is built (osseosynthesis) or replaced with artificial tissue and/or in that a drill hole is provided at the target place in the jaw bone. Then, the dental implant is generally screwed into the jaw bone, for example via its screw thread, as an enossal dental implant or it is just put into it. Within typically three to six months, the dental implant and the surrounding jaw bone unite to form a tight and strong carrier unit. This process is referred to as osseointegration. Dental implants are typically made of titanium or also of ceramic materials.

The connector or abutment, respectively, of the denture is put onto the engrafted dental implant, wherein nowadays a plurality of connection mechanisms are used for connecting the dental implant with the abutment. Nowadays, abutments are, for example, screwed into a dental implants and, for this purpose, the dental implants have internal threads as implant attachment means and the abutments have corresponding external threads. Then, the dental prosthesis is placed onto the abutment, wherein again a plurality of different connection mechanisms are used nowadays. U.S. Pat. No. 6,299,447 B1, for example, which is incorporated herein by reference in its entirety, describes a snap-engagement system as connection mechanism in which the abutment comprises a female part as prosthesis attachment means and the dental prosthesis comprises a corresponding male part.

The structure of an exemplary connector or abutment 10 comprising a male part 130 of a snap-engagement connection system as well as an associated dental implant 20 is shown in FIG. 1 and FIG. 2. In addition to the male part 130, the abutment 10 comprises a body portion 110 and a screw cylinder 120 having an external thread. The screw cylinder 120 is screwed in a hollow cylinder 230 of the dental implant 20 having an internal thread corresponding to the external thread of the screw cylinder 120 so that the abutment 10 and the dental implant 20 are firmly connected with each other. The dental implant 20 comprises a conical body 210 having an external thread 220 and being engrafted into a jaw bone 30 of a patient. The male part 130 comprises an intermediate portion 1320 adjoining the dental implant 20 and being surrounded by the gum or gingiva 40, and a snap-in portion 1310 projecting outwardly beyond said intermediate portion 1320. The male part 130 centrally comprises an opening 1330 through which a turning tool can grip into a corresponding holder 1210 of the abutment 10 and screw the abutment 10 and the dental implant 20 together. The abutment 10 and the dental implant 20 comprise a common central axis 50.

A problem often arising today in connection with a denture as described above results from the fact that the position of the dental implant decisively influences and partly predetermines the position and place of the connector and of its prosthesis attachment means. However, since the exact position of the dental implant depends on various factors, such as, for example, on the condition of the jaw bone, on the course of a possible osseosynthesis and in particular also on an exact insertion of the dental implant, it is regularly not easily possible nowadays to set dental prostheses exactly at a desired target position and in a desired target alignment and to connect them with an associated connector.

This problem is of additional relevance in case of dental prostheses which are intended, for example, for replacing several teeth and which are connected with the jaw bone via several dental implants. It is essential for such a denture that the dental implants as well as the abutments put onto them are arranged in a target position as precisely as possible. In particular, the prosthesis attachment means of the abutments put onto the dental implants typically should be arranged in a way as parallelized with respect to each other as possible in order to enable an easy, stable and long-term connection of the dental prosthesis with the abutments. As described above, however, it is not always possible to position dental implants with sufficient precision and in particular it may even be impossible to engraft them in a parallelized way due to the conditions in the jaw bone. Since the prosthesis attachment means often are not arranged in a way sufficiently parallelized with respect to each other, nowadays some connection mechanisms for connecting dental prostheses with abutments permit a compensation for diverging dental implants to a certain extent. The male parts and/or female parts of snap engagement systems of the kind described above may comprise, for example, deformable caps or inserts made, for example, of polyamide and in particular of polyhexamethylene adipic acid amide. Although snap-engagement systems comprising such caps or inserts permit a compensation for axial divergences of dental implants engrafted in a disparallel way to some limited extent, so much strain is put on the caps or inserts that they regularly have to be exchanged, which may be time-consuming and expensive. Furthermore, mounting the dental prosthesis onto dental implants engrafted in a disparallel way may lead to undesired irritations.

Therefore, there is a need for providing a process or system via which dental prostheses can be inserted in a relatively easy, efficient way and via which deviations from an exact position intended for a dental implant can be compensated for.

### SUMMARY OF THE INVENTION

The invention addresses this and other needs by a process as well as by a milling device, a computer program and a connector. Advantageous embodiments of the process, milling device, computer program and connector according to the invention are also described hereinbelow.

The invention can, in one embodiment, be described as follows: A process for producing a connector for connecting a dental implant with a dental prosthesis, wherein the connector comprises a body portion at whose one end a prosthesis attachment structure and at whose opposite end an implant attachment structure are configured, comprising: collecting implant position data defining the position and alignment of the dental implant inserted in a jaw; determining prosthesis position data defining the target position and target alignment of the prosthesis attachment structure of the connector; and forming the connector using the implant position data and the prosthesis position data, wherein the body portion is configured such that the prosthesis attachment structure is arranged in the target position and target alignment when the connector is attached to the dental implant via the implant attachment structure.

The inventions is also directed at a process for producing a connector for connecting a dental implant with a dental prosthesis, wherein the connector comprises a body portion at whose one end a prosthesis attachment means and at whose opposite end an implant attachment means are configured, comprising the following steps: collecting implant position data defining the position and alignment of the dental implant inserted in a jaw; determining prosthesis position data defining the target position and target alignment of the prosthesis attachment means of the connector; and forming the connector using the implant position data and the prosthesis position data, wherein the body portion is configured such that the prosthesis attachment means is arranged in the target position and target alignment when the connector is attached to the dental via the implant attachment means.

Connectors of the described type are often also referred to as abutments and these two terms are used alternatively herein. The position and alignment of the dental implant inserted in the jaw corresponds in particular to the position and alignment of the dental implant engrafted in a jaw bone. The determination of the prosthesis position data can be carried out, for example, by calculation on the basis of jaw data or in particular also online with the help of a computer. In this connection, data about the oral cavity and in particular the respective jaw can be combined with the implant position data and illustrated, and the dental prostheses can be virtually inserted into this illustration so that the prosthesis position data are thus determined. The one end and the opposite end of the body portion of the connector can correspond to the longitudinal ends of the body portion of the connector.

It is possible with the process according to the invention that the target position and target alignment of the prosthesis attachment structure of the connector can be determined such that the dental prosthesis can be exactly positioned and aligned in the patient's oral cavity even if there are inaccuracies with respect to the position and alignment of the engrafted or implanted dental implant. To this end, in particular an individual connector for the patient is produced with the process according to the invention, said connector comprising a body portion configured so as to be adapted to the exact target position and alignment of the dental prosthesis. The length of the connector, for example, is configured so as to be adapted to the position and alignment of the dental implant implanted into a jaw as well as to the target position and alignment of the prosthesis attachment structure and thus also of the dental prosthesis. Thus, with such an individual connector it is possible to mount the dental prosthesis in a relatively efficient, long-term, easy and stable way without the prosthesis attachment structure being subject to increased strain. Furthermore, such an individual connector can also be produced independently from the type of the engrafted implant.

Preferably, the implant position data define the position and alignment of a further dental implant implanted in the jaw and the prosthesis position data define the target position and the target alignment of the prosthesis attachment structure of a further connector associated to the further dental implant and corresponding to the connector, wherein the prosthesis attachment structure of the connector and the prosthesis attachment structure of the further connector are arranged so as to be parallelized with respect to each other when the connector is connected with the dental implant and the further connector with the further dental implant. In this connection, “parallelized” relates to the alignment of the prosthesis attachment structure relative to the dental prosthesis which is connectable with the several connectors. Corresponding to the described further dental implant, further additional dental implants can be incorporated in the proceedings, depending on how many dental implants are appropriate for the fixation of the dental prosthesis to the jaw. The described parallelization can be of decisive relevance for a high comfort for the patient with respect to the handling and the hygiene friendliness of the denture. In particular, undesired irritations can be reduced or avoided. Moreover, the described parallelization can avoid early wear or excessive strain of the prosthesis attachment structure of the connector and/or the respective attachment structure of the dental prosthesis. Besides, when a snap-engagement connection system is used as the prosthesis attachment structure, it is possible to reduce the number of different inserts or caps enabling a compensated connection, in particular from about six different inserts or caps to about three different inserts or caps.

Advantageously, the body portion of the connector is configured in a bent way when forming the connector. Such a bent configuration comprises all embodiments not extending along a straight axis. It comprises, for example, sinuously curved configurations and in particular also kinked configurations. Axial divergences of several dental implants can be simply compensated and made up for with such bent configurations.

Preferably, the implant position data are collected via scan technology. Such scan technologies, in which in particular appropriate scanners such as laser scanners are used, enable a precise and fast collection of the implant position data.

The implant position data advantageously comprise data concerning the configuration of connector attachment structure of the dental implant, wherein, when forming the connector, the implant attachment structure of the connector is configured so as to correspond to the connector attachment structure of the dental implant. With such a process, the connector can be appropriately configured independently from the connector attachment structure of the dental implant. In particular, it is thus also possible that standard implants can be used and that the individual connector is flexibly configured with appropriate implant attachment structure.

Preferably, when forming the connector, the prosthesis attachment structure is configured as part of a snap-engagement connection, in particular as a male part. The prosthesis attachment structure may also be configured as a female part. The dental prosthesis correspondingly comprises the female or male part. With such a snap-engagement connection, it is possible to connect the dental implant with the one or more connectors in a relatively reliable and easy way. Said female or male part of the connector may comprise various materials and be configured for one of various possible known snap-engagement connection systems. Said female or male part can be configured in particular so as to be adapted to a standard snap-engagement connection system, wherein specific elements thereof, such as, for example, inserts or caps, can be adapted.

A connector attachment structure of the dental implant advantageously comprises an internal thread, wherein, when forming the connector, the implant attachment structure of the connector is configured with a screw hole extending through the body portion. The “screw hole extending through the body portion” comprises in this connection arrangements in which the body portion of the connector has a drill hole extending completely through it in its longitudinal direction from the implant attachment structure to the prosthesis attachment structure as well as arrangements in which the screw hole starts at the implant attachment structure and then breaks through the outer edge of the body portion before the prosthesis attachment structure. This second arrangement can be provided in particular in case of a distinct inclination angle of the prosthesis attachment structure with respect to the longitudinal axis of the connector, wherein, however, the functionality of the prosthesis attachment structure is not decisively impaired. With such a screw hole, the connector can be reliably connected with the dental implant relatively easily via a screw or screw-like element. When forming the connector, the implant attachment structure of the connector is preferably configured with a screw head limit stop adjoining the screw hole. Via such a screw head limit stop, the connector can be reliably pressed against the dental implant in an easy manner via the screw head of the screw connected with the dental implant.

Preferably, the connector is formed by means of a milling process. Such milling processes enable a fast, precise and cost-efficient production of the individual connector. In particular, the milling process can be a CAD/CAM milling process. “CAD” relates to a computer-aided design and “CAM” relates to a computer-aided manufacturing process. In the milling process, the connector is advantageously milled from a base block, wherein the base block comprises titanium, a ceramic material such as zirconium dioxide, a plastic material such as acrylate or polyamide, a cobalt-chromium combination or a mixture thereof.

Another aspect of the invention relates to a milling device for carrying out the above described process. The milling device, such as, for example, a CAD/CAM milling device, comprises an interface, an input and a milling structure, wherein the interface is configured to collect the implant position data, wherein the input is configured to determine the prosthesis position data, and wherein the milling structure is configured to form the connector. The interface can be in particular configured to accept implant position data from a scanner. The input can also be an input interface, for example, to a personal computer, an input mask or a guided visual input. The above described process can be simply and efficiently carried out with such a milling device.

A further aspect of the present invention relates to a computer program for controlling a milling device of the type described above, in particular a CAD/CAM milling device. The computer program comprises a control configured to control the milling structure of the milling device such that the connector is formed taking into account the implant position data collected via the interface and the prosthesis position data determined via the input. With such a computer program, a programmable appropriate milling device can be efficiently configured for carrying out the process according to the invention.

A further aspect of the invention relates to a connector for connecting a dental implant with a dental prosthesis, said connector comprising a body portion at whose one end a prosthesis attachment structure and at whose opposite end an implant attachment structure are configured. The body portion is individually configured so as to be adapted to the position and alignment of the dental implant implanted into a jaw and to a target position and target alignment of the prosthesis attachment structure for the purpose of arranging the dental prosthesis as intended. In this connection, “individual” in particular relates to the length of the body portion and to the bent configuration of it. The connector makes it possible to compensate for inaccuracies during the implantation of the dental implant. In particular it can comprise a body portion configured so as to be adapted to the exact target position of the dental prosthesis. The length and the curvature of the connector can be configured, for example, so as to be adapted to the position and alignment of the dental implant implanted in a jaw as well as to the target position and target alignment of the prosthesis attachment structure. Thus, with such an individual connector it is possible to mount the dental prosthesis in a relatively efficient, long-term, easy and stable way without the prosthesis attachment structure being subject to increased strain.

The implant attachment structure preferably comprises a screw hole extending through the body portion in a longitudinal direction and a screw head limit stop. The “screw hole extending through the body portion” comprises in this connection again arrangements in which the body portion of the connector has a drill hole extending completely through it in its longitudinal direction from the implant attachment structure to the prosthesis attachment structure as well as arrangements in which the screw hole starts at the implant attachment structure and then breaks through the outer edge of the body portion before the prosthesis attachment structure. With such a screw hole, the connector can be reliably connected with the dental implant relatively easily via a screw or screw-like element. The connector comprises preferably a screw which is adapted to the screw hole and the screw head limit stop and which is made of titanium, a chromium-cobalt alloy or a gold alloy and comprises a surface coating for preventing the screw from releasing. Although the screw is preferably made of such a material and provided with such a surface coating, it can also be made of any other appropriate material and/or comprise no such surface coating. Preferably, the connector can be reliably connected with the dental implant via such a screw. Advantageously, the prosthesis attachment structure is configured as part of a snap-engagement connection, in particular as the male part thereof.

### BRIEF DESCRIPTION OF THE DRAWINGS

In the following, the invention is described in more detail with reference to the attached drawings and on the basis of embodiments, wherein

FIG. 1 shows a schematic cross-sectional view of a prior art connector and of a dental implant arranged in a jaw;

FIG. 2 shows a schematic view onto the connector of FIG. 1;

FIG. 3 shows a schematic cross-sectional view of an embodiment of a connector according to the invention and of a dental implant arranged in a jaw; and

FIG. 4 shows a schematic view onto the connector of FIG. 3.

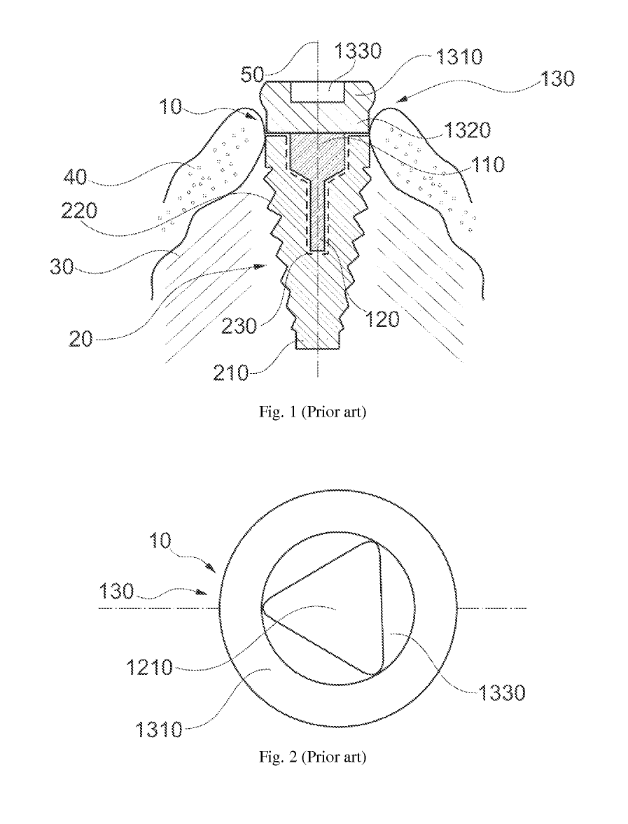

### WAY(S) FOR CARRYING OUT THE INVENTION

In the following description, specific expressions are used for practical reasons and are not to be understood as being restrictive. The terms “right”, “left”, “bottom” and “top” refer to directions in the drawing to which reference is made. The terms “inwardly” and “outwardly” refer to directions towards or away from the geometrical center of the denture and named parts thereof. The terminology comprises the terms explicitly mentioned above, derivations thereof and terms having a similar meaning.

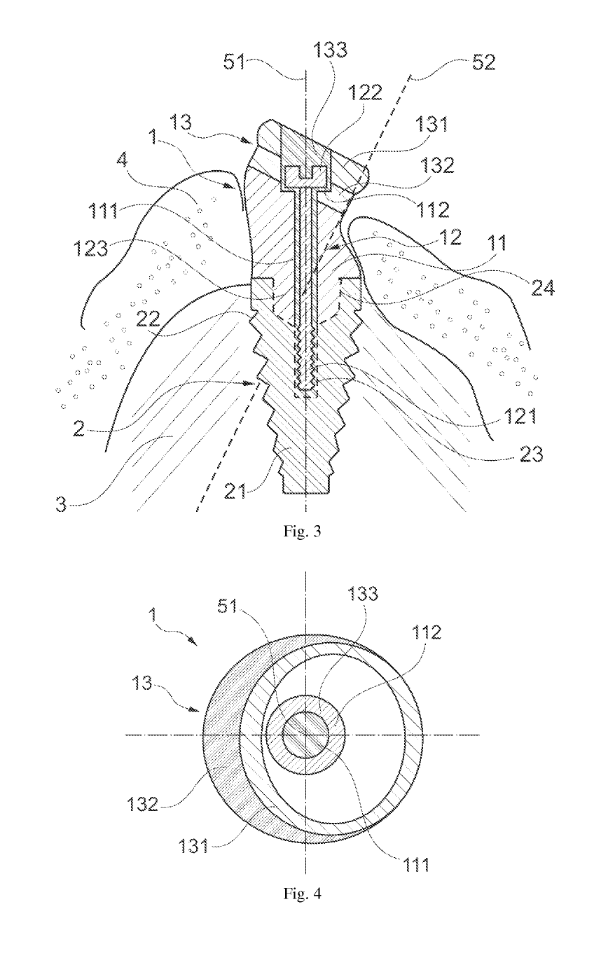

FIG. 3 shows a cross-section of an embodiment of an individual connector 1 or abutment according to the invention. The connector 1 comprises an elongate body portion 11 surrounded by a patient's gum or gingiva 4 and a male part 13 having a cylindrical intermediate portion 132 and a catching portion 131 outwardly radially projecting beyond the intermediate portion 132. A screw hole 111 extends through the body portion 11 in its longitudinal direction and towards the top said screw hole transitions into a hollow-cylindrical opening 133 of the male part 13. The diameter of the opening 133 is configured to be greater than the diameter of the screw hole 111 so that a step 112 is formed as a screw head limit stop at the transition from the screw hole 111 to the opening 133.

The connector 1 comprises an implant attachment structure 12 via which it is firmly connected with a dental implant 2. The dental implant 2 comprises a conical body 21 at whose outside a thread or toothing 22 is arranged and which is engrafted or implanted into a patient's jaw bone 3. The dental implant 2 further comprises a connector attachment structure having a central hollow cylinder 23 with an internal thread and a hollow conical fitting portion 24. The connector 1 further comprises an implant attachment structure 12 comprising a screw with a cylindrical screw body 121 and a screw head 122 as well as a conical fitting portion 123 of the body portion 11. The connector 1 is firmly connected with the dental implant 2 in that the fitting portion 123 of the body portion 11 is inserted into the fitting portion 24 of the dental implant 2 and in that the screw is arranged in a way extending through the screw hole 111 in such a way that the bottom portion of the screw body 121 is screwed into the hollow cylinder 23 of the dental implant 2 and that the screw head 122 at the top rests on the step 112 so that the connector 1 is pressed against the dental implant 2.

The dental implant 2 comprises a central implant axis 51, which is configured in the longitudinal direction and along which the implant attachment structure 12 of the connector 1 are also arranged. The connector 1 further comprises a prosthesis axis 52, along which the male part 13 of the connector 1 is arranged and along which also a female part of an associated dental prosthesis is to be correspondingly arranged. The implant axis 51 is at an angle with respect to the prosthesis axis 52 and, in order to make this possible, the body portion 11 of the connector 1 is configured in a correspondingly bent or kinked way.

FIG. 4 shows a top view onto the connector 1 in the direction of the implant axis 51, wherein no screw is arranged in the screw hole 111. Due to the bent configuration of the body portion 11, the intermediate portion 132 of the male part 13 can be seen on the left side. Furthermore, FIG. 4 shows the engagement portion 131 and the opening 133 of the male part 13 as well as the step 112. As at best apparent from the combination of FIG. 3 and FIG. 4, the screw can be operated through the opening 133 of the male part 13 by means of an appropriate screw driver. For the purpose of mounting the dental prosthesis, a female part of the dental prosthesis is pressed onto the male part 13 of the connector 1 such that the engagement portion 131 of the male part 13 snaps into a corresponding receiving portion of the female part.

For the purpose of producing the connector 1 according to the invention, implant position data defining the position and alignment of the dental implant 2 implanted in the jaw bone 3 are collected with a scanner. To this end, in particular a commercially available laser scanner can be used. Furthermore, prosthesis position data are determined taking into account the conditions in the patient's oral cavity and taking into account the dental prosthesis to be implanted and in particular to be attached to the jaw bone 3 via several dental implants 2. The target position and target alignment of the male part 13 of the connector 1 are defined with these prosthesis position data. The determination of the prosthesis position data can in particular be made online with the help of a computer. To this end, for example, a commercially available personal computer can be used on which a computer program suitable therefor is carried out. The connector 1 is then milled or formed from a titanium block or a similar appropriate block via a milling device according the invention, in particular a CAD/CAM milling device, using the implant position data and the prosthesis position data. The body portion 11 of the connector 1 is configured so as to have such a length and curvature that the male part 13 is arranged in the target position and target alignment when the connector 1 is attached to the dental implant 2 via the implant attachment structure 12.

Although the invention is illustrated and described in detail on the basis of the Figures and the corresponding description, this illustration and this detailed description are to be understood to be illustrative and exemplary and not as restricting the invention. It is self-evident that experts can make changes and adaptations without leaving the scope and the gist of the following claims. In particular, the invention also comprises embodiments with any combination of features which are mentioned or shown above or below in connection with different embodiments. The invention can be realized, for example, also by the following further constructional variations:
Alternatively to the conical form, the engagement portion of the connector can be configured in any other appropriate form, in particular as a cylinder having a pentagonal, hexagonal or octagonal cross-section. In this case, the engagement portion of the dental implant is respectively configured in a corresponding way.
Instead of the screw, the implant attachment structure of the connector can also be configured like a pin and provided, for example, with a snap-in portion. In this case, the connector attachment structure of the dental implant are configured so as to correspond thereto. Further, the implant attachment structure can also form a bayonet catch together with the connector attachment structure. In particular, the implant attachment structure can be configured so as to correspond to known connector attachment structures.

The invention also comprises individual features in the Figures, even if they are shown therein in connection with other features and/or if they are not mentioned above or below. The embodiments described in the Figures and the description and individual features thereof can also be excluded from the subject-matter of the invention.

Moreover, the term “comprise” and derivations thereof do not exclude other elements or steps. Furthermore, the indefinite article “a” and derivations thereof do not exclude a plurality. The functions of several of the features mentioned in the claims can be fulfilled by a unity. The terms “substantially”, “about”, “approximately” and the like in connection with a characteristic or a value in particular also define exactly this characteristic or exactly this value. A computer program can be stored and/or distributed on an appropriate medium, such as, for example, on an optical storage medium or on a fixed medium which is provided together with or as part of other hardware. It may also be distributed in another form, such as, for example, via the Internet or other wired or wireless telecommunication systems. In particular, a computer program can be, for example, a computer program product stored on a computer-readable medium which is configured to be carried out in order to implement a process, in particular the process according to the invention. All reference signs in the claims are not to be understood as restricting the scope of the claims.

Once given the above disclosure, many other features, modifications, and improvements will become apparent to the skilled artisan. Such other features, modifications, and improvements are therefore considered to be part of this invention, the scope of which is to be determined by the following claims.

1. A process for producing a connector for connecting a dental implant with a dental prosthesis, wherein said connector comprises a body portion at whose one end a prosthesis attachment structure and at whose opposite end an implant attachment structure are configured, comprising
collecting implant position data defining the position and alignment of the dental implant inserted in a jaw;
determining prosthesis position data defining a target position and target alignment of the prosthesis attachment structure of the connector; and
forming said connector using the implant position data and the prosthesis position data, wherein said body portion is configured such that the prosthesis attachment structure is arranged in the target position and target alignment when said connector is attached to the dental implant via the implant attachment structure.

2. The process according to claim 1, in which the implant position data define a position and alignment of a further dental implant implanted in the jaw and in which the prosthesis position data define a target position and target alignment of a prosthesis attachment structure of a further connector associated to the further dental implant and corresponding to the connector, wherein the prosthesis attachment structure of the connector and the prosthesis attachment structure of the further connector are arranged so as to be parallelized with respect to each other when the connector is connected with the dental implant and the further connector is connected with the further dental implant.

3. The process according to claim 1, wherein the body portion of the connector is configured in a bent way when forming the connector.

4. The process according to claim 1, in which the implant position data are collected via a scan technology.

5. The process according to claim 1, in which the implant position data comprise data concerning a configuration of a connector attachment structure of the dental implant, wherein, when forming the connector, the implant attachment structure of the connector is configured so as to corresponding to the connector attachment structure of the dental implant.

6. The process according to claim 1, wherein, when forming the connector, the prosthesis attachment structure is configured as part of a snap-engagement connection, in particular as a male part.

7. The process according to claim 1, wherein a connector attachment structure of the dental implant comprises an internal thread and wherein, when forming the connector, the implant attachment structure of the connector is configured with a screw hole extending through the body portion.

8. The process according to claim 7, wherein, when forming the connector, the implant attachment structure of the connector is configured with a screw head limit stop adjoining the screw hole.

9. The process according to claim 1, wherein the connector is formed via a milling process.

10. The process according to claim 9, in which, in the milling process, the connector is milled from a base block, wherein the base block comprises titanium, a ceramic material such as zirconium dioxide, a plastic material such as acrylate or polyamide, a cobalt-chromium combination or a mixture thereof.

11. A milling device for carrying out the process according to claim 1, said milling device comprising an interface, an input and a milling structure, wherein said interface is configured to collect the implant position data, wherein said input is configured to determine the prosthesis position data, and wherein said milling structure is configured to form the connector.

12. A computer program for controlling a milling device according to claim 11, which comprises a control configured to control the milling structure of the milling device such that the connector is formed taking into account the implant position data collected via the interface and the prosthesis position data determined via the input.

13. A connector for connecting a dental implant with a dental prosthesis, said connector comprising a body portion at whose one end a prosthesis attachment structure and at whose opposite end an implant attachment structure are configured, wherein the body portion is individually configured so as to be adapted to a position and alignment of the dental implant implanted into a jaw and to a target position and target alignment of the prosthesis attachment structure for purpose of arranging the dental prosthesis as intended.

14. The connector according to claim 13, in which the implant attachment structure comprise a screw hole extending through the body portion in a longitudinal direction and a screw head limit stop.

15. The connector according to claim 14, which comprises a screw which is adapted to the screw hole and the screw head limit stop and which is made of titanium, a chromium-cobalt alloy or a gold alloy and comprises a surface coating for preventing the screw from releasing.

16. The connector according to claim 13, in which the prosthesis attachment structure is configured as part of a snap-engagement connection, in particular as a male part.

17. The connector according to claim 14, in which the prosthesis attachment structure is configured as part of a snap-engagement connection, in particular as a male part.

18. The connector according to claim 15, in which the prosthesis attachment structure is configured as part of a snap-engagement connection, in particular as a male part.
